(19) United States
(12) Patent Application Publication
(10) Pub. No.: US 2016/0129466 A1
(43) Pub. Date: May 12, 2016

(54) PAINT ROBOT SYSTEM AND METHOD FOR SPRAY PAINTING A WORKPIECE

(71) Applicant: HONDA MOTOR CO., LTD., TOKYO (JP)

(72) Inventor: Richard William Turnbull, Ontario (CA)

(73) Assignee: HONDA MOTOR CO., LTD., TOKYO (JP)

(21) Appl. No.: 14/534,783

(22) Filed: Nov. 6, 2014

(51) Int. Cl. B05B 15/08; B05B 3/10; B05B 12/08; B25J 9/16; B05D 1/02; B05B 12/00

(52) U.S. Cl. CPC B05B 15/08; B05D 1/02; B05B 12/004; B05B 12/08; B25J 9/1682; B25J 9/1679; B05B 3/1014; Y10S 901/02; Y10S 901/09

(57) ABSTRACT

A paint robot system includes a paint spray gun configured to spray paint onto a workpiece. The paint spray gun has a nozzle where the paint exits the paint spray gun. A robot arm moves the paint spray gun relative to the workpiece. A processor module receives a color input relating to a color of paint for the workpiece. The processor module determines a paint spray gun distance based on the color input, where different colors have different paint spray gun distances. The processor module controls the robot arm to position the nozzle at the paint spray gun distance.

### BACKGROUND

The present disclosure relates generally to a paint robot system and method for spray painting a workpiece.

Paint robot systems are used in various industries, such as the automobile industry, employing automated line production processes for efficiently mass-producing products. The paint robot systems apply a paint coating to a surface of the workpiece, such as the automotive vehicle body or body parts, such as the bumpers, which is being conveyed along a paint coating line. Robotic painting processes are used for painting the workpieces. For example, a paint spray gun is provided at an end of an arm of a robot, which moves the paint spray gun in a predetermined pattern to apply paint to the various surfaces of the workpiece.

Conventional paint robot systems hold the paint spray gun a fixed distance from the workpiece and vary or adjust certain painting parameters to adjust for painting effect and coverage. For example, conventional paint robot systems adjust fluid delivery, pattern, shape and high voltage electric charge to control the painting effect. Achieving a consistent color over an entire workpiece, which may be referred to as color matching, is challenging, especially with larger workpieces. For example, with conventional paint robot systems, inconsistent color matching may be caused by the lag time between applying different coats in different areas of the workpiece. The variable lag times may cause the paint to be dryer or wetter in certain areas, contributing to inconsistent color. Some systems use the paint robot systems to reapply or wet certain areas to improve color matching. However, this leads to additional paint use and additional cost. To avoid mottling and over-wetting of the surface, paint robot systems typically have a high gun-to-part distance, which causes the paint to be applied relatively dry. However, higher gun-to-part distances lower transfer efficiency and increase the amount of paint wasted as less paint particles attach to the surface of the workpiece.

### BRIEF DESCRIPTION

In one embodiment, a paint robot system is provided that includes a paint spray gun configured to spray paint onto a workpiece. The paint spray gun has a nozzle where the paint exits the paint spray gun. A robot arm moves the paint spray gun relative to the workpiece. A processor module receives a color input relating to a color of paint for the workpiece. The processor module determines a paint spray gun distance based on the color input, where different colors have different paint spray gun distances. The processor module controls the robot arm to position the nozzle at the paint spray gun distance.

In another embodiment, a method of operating a paint robot that includes a paint spray gun having a nozzle and a robot arm moving the paint spray gun is provided. The method includes receiving a color input relating to a color of paint for a workpiece, determining a paint spray gun distance based on the color input, wherein different colors have different paint spray gun distances, and positioning the nozzle of the paint spray gun at the paint spray gun distance while operating the paint spray gun.

In a further embodiment, a tangible and non-transitory computer readable medium is provided having one or more computer software modules configured to direct one or more processors to receive a color input relating to a color of paint for a workpiece, determine a paint spray gun distance based on the color input, wherein different colors have different paint spray gun distances, and position the nozzle of the paint spray gun at the paint spray gun distance while operating the paint spray gun.

### BRIEF DESCRIPTION OF THE DRAWINGS

FIG. 1 is a schematic illustration of a painting system in accordance with one embodiment.

FIG. 2 is a perspective view of an exemplary paint spray gun that may be included in the painting system shown in FIG. 1.

FIG. 3 is a perspective view of the paint spray gun shown in FIG. 2 at a first paint spray gun distance relative to a workpiece.

FIG. 4 is a perspective view of the paint spray gun shown in FIG. 2 at a second paint spray gun distance relative to a workpiece.

FIG. 5 illustrates a portion of the painting system shown in FIG. 1 showing a nozzle of the paint spray gun in different positions for spraying different areas of the workpiece.

FIG. 6 is a chart showing variable painting parameters for operating the painting system shown in FIG. 1.

FIG. 7 shows a method of operating a paint robot in accordance with an exemplary embodiment.

### DETAILED DESCRIPTION

Various embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of methods and systems for painting a workpiece, such as the body, panels or parts of a vehicle, are provided. It should be noted that although the various embodiments are described in connection with paining vehicle body panels, one or more embodiments may be implemented in different applications, such as for painting non-automotive components.

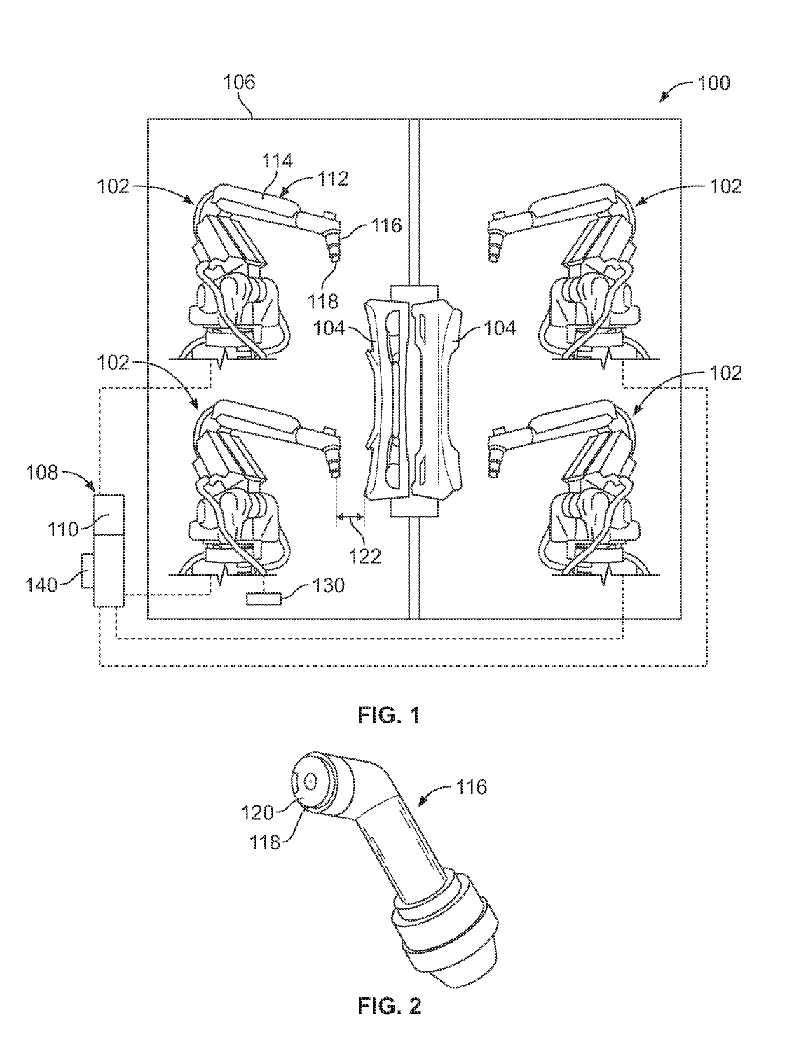

FIG. 1 is a schematic illustration of a painting system 100 in accordance with one embodiment. The painting system 100 may be used in an assembly line, such as in an automotive assembly plant. The painting system 100 may employ a painting method in accordance with an exemplary embodiment. The painting system 100 may form one of numerous painting stages or stations, which may be used for painting different parts or components of the vehicle. Optionally, the painting system 100 may be an electrostatic painting or coating system in which the paint is electrostatically applied to the items being painted.

The painting system 100 includes one or more paint robot systems 102 used for spray painting one or more workpieces 104. The painting system 100 includes a painting station or painting booth 106 with the paint robot systems 102 located within the painting booth 106 for painting the workpieces 104. The painting booth 106 may at least partially enclose the workpieces 104, such as to contain the paint being sprayed onto the workpieces 104. The painting booth 106 may reduce drafts or air movement around the workpieces 104 to enhance the spray painting process. The workpieces 104 may be automatically moved through the painting booth 106, such as on a conveyor or other motive machine.

The paint robot systems 102 are controlled by one or more painting controller(s) 108. Optionally, each of the paint robot systems 102 may be communicatively and operably coupled to a main or central painting controller 108. Alternatively, each individual paint robot system 102 may include a separate painting controller 108, which may be communicatively coupled to a central or main controller. The painting controller 108 includes one or more processor modules that control various operating or painting characteristics used in the painting process(es). The processor module 110 controls the painting process(es) to ensure that the different areas of the workpieces 104 have uniform coating and/or matching color with other areas of the workpiece 104 and with other workpieces 104 of the vehicle (e.g., the bumper has matching color to the vehicle body). In an exemplary embodiment, the processor module 110 controls painting parameters based on the color of the paint. For example, for different colors, the processor module 110 may change different painting parameters. The processor module 110 operates the paint robot systems 102 to ensure that the paint robot systems 102 do not collide during operation. The processor module 110 operates the paint robot systems 102 to efficiently use and/or conserve the paint, such as for cost control. The processor module 110 operates the paint robot systems 102 for paint-to-part transfer efficacy and/or to reduce paint waste.

Each paint robot system 102 includes a paint robot 112 having an arm 114 configured to move in three dimensional space (e.g., movable in X, Y and Z directions). A paint spray gun 116 is provided at or near an end of the arm 114. The paint spray gun 116 may be any type of paint spray gun, such as an electrostatic spray gun, a rotational bell spray gun, a high-volume low-pressure spray gun, a low-volume low-pressure spray gun, or any other type of paint spray gun. The paint spray gun 116 may electrically charge the paint or coating particles.

FIG. 2 is a perspective view of an exemplary paint spray gun 116. The paint spray gun 116 includes a nozzle 118 where the paint exits the paint spray gun 116. The nozzle 118 may control the spray pattern (e.g., size—wide, normal or narrow; shape—circular, oval, flat; and the like) of how the paint is spread and sprayed onto the workpiece 104. Optionally, the nozzle 118 may include a spinning metal disc 120, which may be referred to as a rotating bell cup 120, where the paint is flung toward the workpiece 104, and which may impart an electrical charge to the paint or coating particles.

Returning to FIG. 1, the paint spray gun 116 is used to spray the paint on the workpiece 104 in a uniform manner. Various painting parameters of the paint spray gun 116 may be controlled or changed to change the painting effect, such as by the painting controller 108. For example, the processor module 110 may be programmed to change a spray pattern of the paint spray gun 116, such as by controlling a volume of shape air, a speed of shape air, and the like. The processor module 110 may be programmed to change a fluid flow rate of either the paint or the air to the paint spray gun 116. The processor module 110 may be programmed to change a bell cup rotational speed of the bell cup of the paint spray gun 116, when used. The processor module 110 may be programmed to change a high voltage electrical charge of the paint spray gun 116. The processor module 110 may be programmed to control the painting pattern or path of the paint spray gun 116. Other painting parameters may be controlled to change the painting effect in other embodiments. In an exemplary embodiment, some or all of the painting parameters may be changed based on the color of the paint being used, because different colors may need to be applied differently to achieve a uniform, consistent, high quality paint finish on the workpiece 104. In an exemplary embodiment, a distance 122 between the paint spray gun 116 and the workpiece 104, known as gun-to-part distance or paint spray gun distance 122, may be changed to change the painting effect. For example, the processor module 110 may be programmed to change the paint spray gun distance 122 based on the color of the paint.

The arm 114 may be movable vertically (e.g., up and down), horizontally (e.g., left and right) and/or may be rotated by the paint robot 112 along a paint spray gun painting pattern to paint the different areas of the workpiece 104. The paint spray gun painting pattern may be a rainbow pattern, a side-to-side pattern or other typical painting pattern for uniformly covering the whole workpiece 104. The arm 114 may have multiple joints that allow movement of the paint spray gun 116 in many directions. As such, the paint spray gun 116 may be manipulated into many different orientations, such as at various angles, locations and the like for painting all areas and contours of the workpiece 104. In an exemplary embodiment, the arm 114 is manipulated to generally hold the nozzle 118 of the paint spray gun 116 at the predetermined paint spray gun distance 122 from the workpiece 104 for uniform covering of the surface. In an exemplary embodiment, the processor module 110 determines the paint spray gun distance 122 based on the color of the paint being sprayed. The arm 114 moves the paint spray gun 116 to follow the contour of the workpiece 104.

In an exemplary embodiment, the painting system 100 includes a workpiece color sensor 130 configured to inspect a surface of the workpiece 104 after the painting operation to identify the color of the workpiece 104. Any type of inspection sensor or device capable of identifying color of the workpiece 104 may be used in various embodiments. The color sensor 130 identifies if a portion or portions of the workpiece 104 are trending out of specification and sends color data to the painting controller 108, which may adjust one or more painting parameters based on the color data. In other embodiments, the color sensor 130 may sense a color of the paint being used, such as at a paint supply or source location and sends color data to the painting controller 108, which may adjust one or more painting parameters based on the color data.

In an exemplary embodiment, the painting system 100 includes a user interface 140 communicatively coupled to the painting controller 108. Optionally, the user interface 140 may be part of the painting controller 108, such as on a common circuit board. The user interface 140 receives inputs from a user to control the painting operation. For example, the user interface 140 may receive inputs that change painting parameters of the painting system. For example, the user interface 140 may receive inputs relating to the color, the spray pattern, the fluid flow rate, the bell cup rotational speed, the HV electrical charge, or other painting parameters. The user interface 140 may include input buttons, knobs, scroll wheels, keypads, keyboards, a touchscreen, a mouse, voice recognition, and the like. The user interface 140 may be part of a computer at a remote location from the paint robot systems 102 that is connected by a communication network. The user interface may include a display for the user.

The painting controller 108 includes one or more modules that receive inputs, determine painting parameters and/or control positioning of the paint spray gun 116. For example, the processor module 110 may receive inputs from the color sensor 130, from the user interface 140, and the like. Optionally, raw data may be transmitted to the processor module 110 and the processor module 110 may process the raw data received to determine the painting parameters and/or the control of the paint robot system 102. The processor module 110 may determine the paint spray gun distance 122, the spray pattern of the paint spray gun 116, the fluid flow rate of the paint spray gun 116, the bell cup rotational speed of the bell cup of the paint spray gun 116, the high voltage electrical charge of the paint spray gun 116, or other painting parameters. The processor module 110 controls movement of the paint robot 112, such as to control the position of the arm 114 and paint spray gun 116 relative to the surfaces of the workpiece 104. The movement of the paint spray gun 116 is controlled to target the particular location or area of the workpiece 104. The movement of the paint spray gun 116 is controlled to attack the surface(s) from an efficient and/or optimal orientation. The paint spray gun 116 orientation is selected based on the angle, contour and/or curvature of the surface. The processor module 110 may be operably coupled to the paint spray gun 116, such as to control an ON/OFF state of the paint spray gun 116.

The processor module 110 may form part of or be embodied as one or more computing systems, such as one or more PLCs. It should be noted that while a particular computing or operating environment may be described herein, the computing or operating environment is intended to illustrate operations or processes that may be, implemented, performed, and/or applied to a variety of different computing or operating environments. Thus, FIG. 1 illustrates a non-limiting example of a controller that may perform one or more methods or processes as described in more detail herein.

The processor module 110 may be provided, for example, as any type of computing device, including, but not limited to PLCs or personal computing systems, among others. The processor module 110 may optionally include components not shown in FIG. 1, and/or some components shown in FIG. 1 may be peripheral components that do not form part of or are not integrated into the computing system. The processor module 110 may include one or more physical devices configured to execute one or more instructions. For example, the processor module 110 may be configured to execute one or more instructions that are part of one or more programs, routines, objects, components, data structures, or other logical constructs. Such instructions may be implemented to perform a task, implement a data type, transform the state of one or more devices, or otherwise arrive at a desired result.

The processor module 110 may include one or more processors and/or computing devices that are configured to execute software instructions, such as programmed using application software. In some embodiments, one or more algorithms as described herein are embedded into the PLC. Additionally or alternatively, the processor module 110 may include one or more hardware or firmware logic machines configured to execute hardware or firmware instructions. The processor module 110 may optionally include individual components that are distributed throughout two or more devices, which may be remotely located in some embodiments, such as in the various machines, systems, and the like of the painting system 100.

Thus, the various components, subsystems, or modules of the painting system 100 may be implemented in hardware, software, or a combination thereof, as described in more detail herein. Additionally, the processes, methods, and/or algorithms described herein may be performed using one or more processors, processing machines or processing circuitry to implement one or more methods described herein.

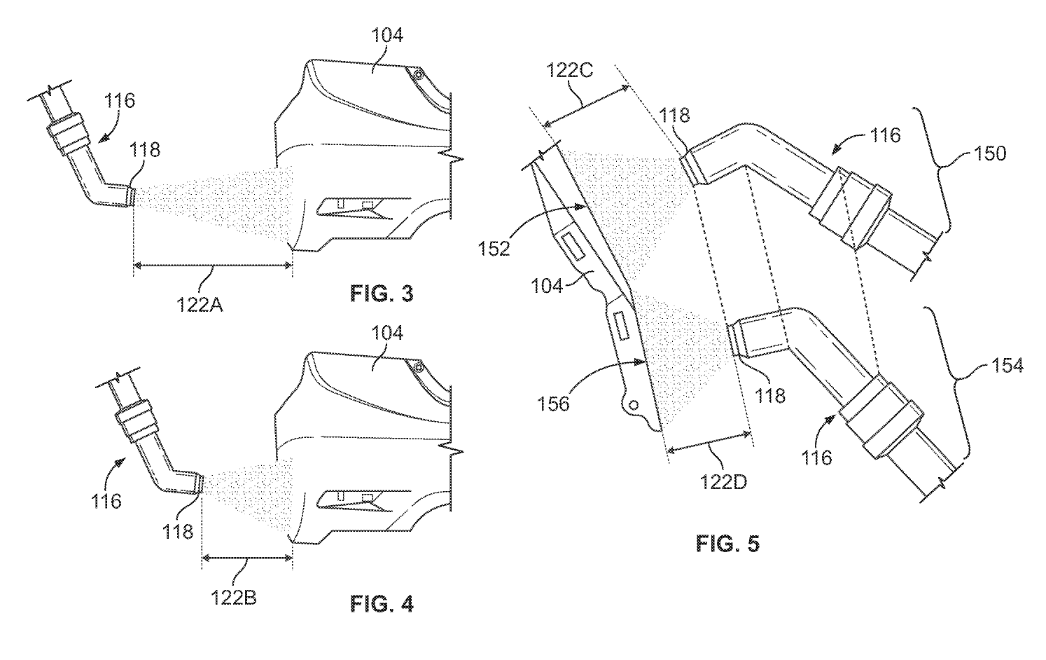

FIGS. 3 and 4 illustrate the paint robot system 102 painting the workpiece 104. FIG. 3 shows the paint spray gun 116 at a first paint spray gun distance 122A. FIG. 4 illustrates the paint spray gun 116 at a second paint spray gun distance 122B that is less than the first distance 122A. Having the paint spray gun 116 at different distance 122A, 122B provides different painting effects on the workpiece 104. For example, when the paint spray gun 116 is held further from the workpiece 104 (FIG. 3), the paint may be applied dryer. The paint spray pattern may be wider. When the paint spray gun 116 closer to the workpiece 104 (FIG. 4), the paint may be applied wetter. The paint spray pattern may be narrower or more focused. The high voltage electrical charge may be more effective when the paint spray gun 116 is closer to the workpiece 104. The transfer efficacy of the paint may be higher when the paint spray gun 116 is closer because less paint may be wasted as more of the paint is applied to the workpiece 104.

Some types of paint may be applied more effectively with the paint spray gun 116 positioned closer to the workpiece 104. Other paint types may be applied more effectively with the paint spray gun 116 further from the workpiece 104. For example, metallic colors having metallic flakes may mottle when the paint is sprayed in a wet condition. The metal flakes may partially stand up and create shadows if the paint spray gun 116 is too close to the workpiece 104. For example, when the metallic paints are applied wet the metallic flakes do not lay flat on the surface and the quality of the paint job is diminished. As such, metallic paint may be more effectively applied having a greater paint spray gun distance 122A than other paint colors. In contrast, solid paint colors, such as paint colors without metallic flakes, may be applied more effectively with a closer paint spray gun distance 122B. For example, solid paint colors may be applied wetter with the paint spray gun 116 closer to the workpiece 104, which may lead to less waste of the paint. Other paint colors, such a pearlescent paint colors may be most efficiently applied at a paint spray gun distance that is between the first and second distances 122A, 122B. For example, pearlescent paint colors may be less affected by shadowing and mottling than metallic paints allowing the pearlescent paints to be sprayed from a distance closer than the first paint spray gun distance 122A, leading to less waste than when sprayed from the first distance 122A.

In an exemplary embodiment, when the paint spray gun 116 is positioned closer to the workpiece 104 (FIG. 4), the spray pattern may need to be widened for full coverage of certain areas of the workpiece 104, such as to have an equivalent width as the paint sprayed from the first paint spray gun distance 122A. The processor module 110 (shown in FIG. 1) may adjust the spray pattern based on the paint spray gun distance 122A, 122B, such as by controlling a volume of shape air, a volume of paint, a speed of shape air, and the like. The spray pattern may be controlled by adjusting the rotational speed of the bell cup 120 (shown in FIG. 2). The pattern may be adjusted by controlling the flow rate of the paint and/or the air to the nozzle 118.

Optionally, the processor module 110 may control the high voltage electrical charge based on the paint spray gun distance 122A, 122B. For example, when the paint spray gun 116 is positioned further from the workpiece 104, the high voltage electrical charge may be increased as compared to the electrical charge level needed when the paint spray gun 116 is at the second distance 122B.

In an exemplary embodiment, the paint spray gun 116 may be positioned at different paint spray gun distances 122A, 122B based on the paint coat being applied. For example, when a first or under paint coat is being applied, such under paint coat may be thicker and it may be desirable to position the paint spray gun 116 closer to the workpiece 104 when applying the under paint coat. Such under paint coat may be applied wetter and more efficiently, with less waste, by positioning the paint spray gun 116 closer to the workpiece 104. The second or outer paint coat may be applied thinner and dryer for a better finish. Such outer coat may be applied with the paint spray gun 116 further from the workpiece 104. The processor module 110 may determine which paint coat is being applied and may determine the paint spray gun distance 122A, 122B based on the paint coat being applied.

FIG. 5 illustrates a portion of the paint robot system 102 showing the nozzle 118 in a first position 150 for spraying a first area 152 of the workpiece 104 and in a second position 154 for spraying a second area 156 of the workpiece 104. The paint robot 112 (shown in FIG. 1) is able to move the nozzle 118 of the paint spray gun 116 for spraying the different areas 152, 156 of the workpiece 104. In an exemplary embodiment, in the first position 150 the paint spray gun 116 is held at a first paint spray gun distance 122C and in the second position 154 the paint spray gun 116 is held at a second paint spray gun distance 122D that is less than the first paint spray gun distance 122C.

While painting large areas of the workpiece 104, the paint spray gun 116 may be generally held at a constant paint spray gun distance 122 during a paint stroke along a section or segment of the workpiece 104. However, when the paint spray gun 116 is used to paint a different area, such as the second area 156, the paint spray gun 116 may be positioned at a different paint spray gun distance 122D than when painting the first area 152. During painting of the second area 156, the paint spray gun 116 may be held at a generally constant paint spray gun distance 122D. Holding the paint spray gun 116 at different distance 122C, 122D may allow a different amount of paint to be applied to the workpiece 104 in the areas 152, 156, such as to control the painting effects in those areas 152, 156. For example, the different areas 152, 156 may be exposed to different lighting levels needing a slightly different color effect. For example, the first area 152 may be a top of the bumper while the second area 156 may be a front of the bumper needing a different color effect. The first area 152 may be the front of the bumper and the second area 156 may be a side of the bumper needing a different color effect. The first area 152 may be a generally flat area while the second area 156 may be a heavily contoured area needing a different color effect.

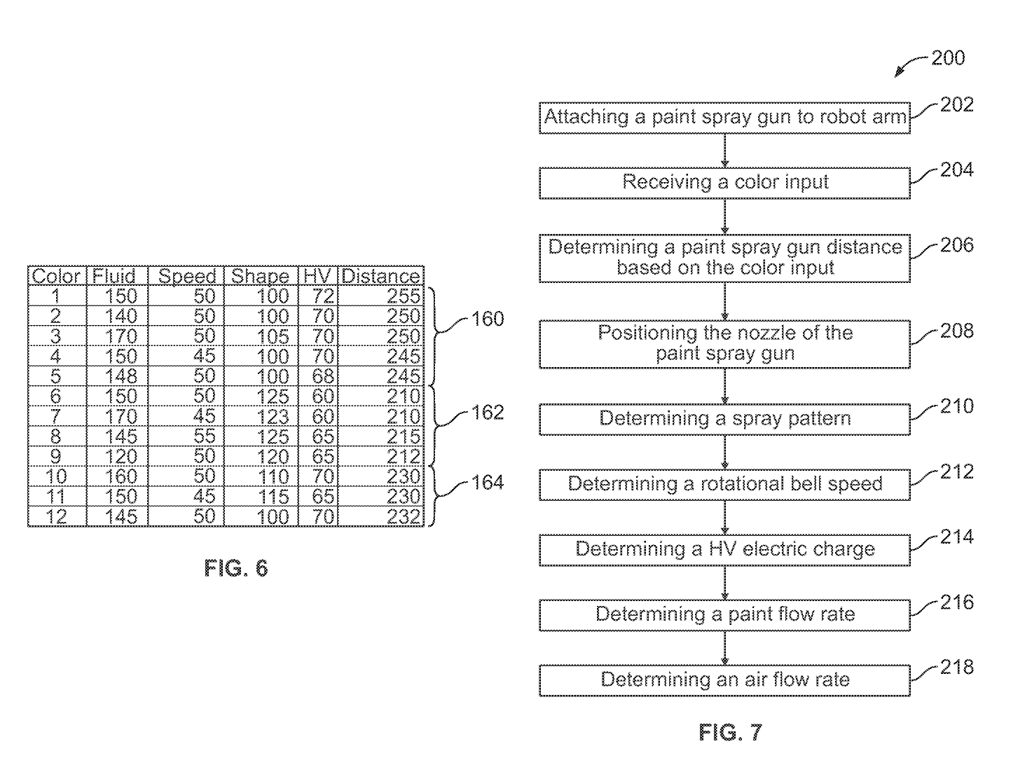

FIG. 6 illustrates a chart showing variable painting parameters for various colors. In the chart, the different colors are identified by different numbers; however the colors may be identified by names or other identifying indicia in alternative embodiments. The painting parameters illustrated in FIG. 6 include a fluid flow rate, a bell speed, a pattern or shape, a high voltage electrical charge rate, and a paint spray gun distance. Other variable painting parameters may be used in alternative embodiments based on the color of the paint. For a given color, any number of the variable painting parameters may be the same as other colors.

The processor module 110 (shown in FIG. 1) may use the chart as a lookup table for determining one or more painting parameters based on a color input relating to a color of paint for the workpiece 104 (shown in FIG. 1). Optionally, for a given color, the painting parameters may vary or change based on another variable. For example, the painting parameters may change based on the area of the workpiece being painted. For example, in some areas the paint spray gun 116 may have a first distance while in other areas the paint spray gun 116 may have a different second distance. Similarly, in one area, the paint spray gun 116 may deliver the fluid at a first flow rate, but in a second area the paint spray gun 116 may deliver the fluid at a second flow rate. As such, there may be multiple lookup tables depending on certain variables, such as the area of the workpiece being painted. In other embodiments, different paint robot systems 102 may have different lookup tables. For example, because some paint robot systems 102 may paint different workpieces or different sections of the workpieces, the paint robot systems 102 may have different lookup tables with different variables. In some embodiments, different areas of the painting booth 106 (shown in FIG. 1) may have different environmental impacts, such as different down drafts or air flows in the different areas of the painting booth 106, such that the paint robot systems 102 in the different sections of the painting booth 106 may require different painting parameters or variables based on being located in such areas of the painting booth 106. Optionally, the painting booth 106 may have sensors used to sense downdrafts or air flow in the various areas of the painting booth 106 and the processor module 110 may adjust one or more variable painting parameters, such as the paint spray gun distance 122, based on measurements from such sensors.

Optionally, the colors may be grouped into various groups. For example, FIG. 6 illustrates a first group 160, a second group 162 and a third group 164. Any number of groups may be provided. The paint spray gun distances 122 of the colors in the first group 160 are greater than the paint spray gun distances 122 of the colors in the second group 162. Optionally, the paint spray gun distances 122 of the colors in the third group 164 are between the paint spray gun distances 122 of the first group 160 and the paint spray gun distances 122 of the second group 162. For example, the colors of the first group 160 may correspond to metallic colors, the colors of the second group may correspond to solid colors, and the colors of the third group may correspond to pearlescent colors. Optionally, the paint spray gun distances 122 of each color within the first group may be the same, as in the illustrated embodiment. Alternatively, the paint spray gun distances 122 of the colors within a group may be different, such as within a predetermined range, but such range may be different than the range for different groups.

FIG. 7 shows a method 200 of operating a paint robot in accordance with an exemplary embodiment. The method 200, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 200 may be able to be used as one or more algorithms to direct hardware to perform operations described herein.

The method 200 includes attaching 202 a paint spray gun having a nozzle to a programmable robot arm. The programmable robot arm may be controlled by a processor module move the paint spray gun in various directions and orientations for spray painting a workpiece. The paint spray gun may be controlled by a processor module to apply the spray paint coating to the workpiece.

The method 200 includes receiving 204 a color input relating to a color of paint for the workpiece. The color input may be manually input by a user, such as into a user interface associated with the processor module. Alternatively, the color input may be automatically input, such as by a color sensor.

The method 200 includes determining 206 a paint spray gun distance based on the color input. The paint spray gun distance is variable and may be different for different colors. For example, metallic colors may be associated with a further paint spray gun distance while solid colors may be associated with a closer paint spray gun distance. The paint spray gun distance may be different depending on the area of the workpiece being sprayed. The paint spray gun distance may be different depending on the coat being applied.

The method 200 includes positioning 208 the nozzle of the paint spray gun at the paint spray gun distance while operating the paint spray gun. The processor module may control the robot arm to position the paint spray gun at the paint spray gun distance.

The method 200 includes determining 210 a spray pattern based on the paint spray gun distance. The method 200 includes determining 212 a rotational bell speed for the bell cup of the nozzle based on the paint spray gun distance. The method 200 includes determining 214 a high voltage electric charge based on the paint spray gun distance. The method 200 includes determining 216 a flow rate of the paint based on the paint spray gun distance. The method 200 includes determining 218 a flow rate of the air based on the paint spray gun distance.

Various embodiments describe herein provide a painting system that is capable of painting a workpiece with a paint spray gun in a reliable and consistent manner. The painting system controls the positioning of the paint spray gun relative to the workpiece in a manner that ensures a quality paint job and with high transfer efficacy by reducing waste of paint. The painting system controls the paint spray gun distance to the workpiece based on the color being painted to reduce waste of paint.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. For example, a module or system may include a computer processor, controller, or other logic-based device that performs operations based on instructions stored on a tangible and non-transitory computer readable storage medium, such as a computer memory. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, paragraph (f), unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

The foregoing description of embodiments and examples has been presented for purposes of illustration and description. It is not intended to be exhaustive or limiting to the forms described. Numerous modifications are possible in light of the above teachings. Some of those modifications have been discussed and other will be understood by those skilled in the art. The embodiments were chosen and described for illustration of various embodiments. The scope is, or course, not limited to the examples or embodiments set forth herein, but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A paint robot system comprising:
a paint spray gun configured to spray paint onto a workpiece, the paint spray gun having a nozzle where the paint exits the paint spray gun;
a robot arm moving the paint spray gun relative to the workpiece; and
a processor module receiving a color input relating to a color of paint for the workpiece and determining a paint spray gun distance based on the color input, wherein different colors have different paint spray gun distances, the processor module controlling the robot arm to position the nozzle at the paint spray gun distance.

2. The paint robot system of claim 1, further comprising a user interface communicatively coupled to the processor module, the user interface configured to receive a user input relating to color.

3. The paint robot system of claim 1, further comprising a color sensor configured to sense a color of paint being used by the paint spray gun, the processor module receiving the color input from the color sensor to determine the paint spray gun distance.

4. The paint robot system of claim 1, wherein the robot arm holds the nozzle of the paint spray gun at a constant paint spray gun distance determined by the processor module based on the color being painted.

5. The paint robot system of claim 1, wherein colors are grouped into a first group and second group, the paint spray gun distance of the colors in the first group being greater than the spray gun distance of the colors in the second group.

6. The paint robot system of claim 5, wherein the colors of the first group are metallic colors having metal flakes, and wherein the colors of the second group are nonmetallic colors.

7. The paint robot system of claim 6, further comprising colors grouped into a third group, the paint spray gun distance of the colors in the third group being between the paint spray gun distance of the first group and the paint spray gun distance of the second group, the colors of the third group being pearlescent.

8. The paint robot system of claim 1, wherein the processor module determines a spray pattern of the nozzle based on the paint spray gun distance, the pattern being different for different paint spray gun distances.

9. The paint robot system of claim 1, wherein the processor module determines a fluid flow rate of the paint from the nozzle based on the paint spray gun distance, the fluid flow rate being different for different paint spray gun distances.

10. The paint robot system of claim 1, wherein the paint spray gun further comprises a rotating bell cup, the processor module determining a bell cup rotation speed of the bell cup based on the paint spray gun distance, the bell cup rotation speed being different for different paint spray gun distances.

11. The paint robot system of claim 1, wherein the processor module determines a paint spray gun painting pattern to paint different areas of the workpiece, the processor module determining a paint spray gun distance based on the area of the workpiece being painted, wherein, in different areas, the paint spray gun has different paint spray gun distances.

12. The paint robot system of claim 1, wherein the processor module determines a paint coat being a first paint coat or a second paint coat, the processor module determining a paint spray gun distance based on the paint coat, wherein, for a given color the paint spray gun distance of the first paint coat is different than the paint spray gun distance of the second coat.

13. The paint robot system of claim 1, further comprising a second paint spray gun configured to spray the same color paint on the workpiece and a second robot arm moving the second paint spray gun, the processor module determining different paint spray gun distances for the paint spray gun and the second paint spray gun.

14. A method of operating a paint robot that includes a paint spray gun having a nozzle and a robot arm moving the paint spray gun, the method comprising:
receiving a color input relating to a color of paint for a workpiece;
determining a paint spray gun distance based on the color input, wherein different colors have different paint spray gun distances; and
positioning the nozzle of the paint spray gun at the paint spray gun distance while operating the paint spray gun.

15. The method of claim 14, wherein said receiving a color input comprises receiving a color input from a user at a user interface.

16. The method of claim 14, said positioning the nozzle of the paint spray gun comprises positioning the nozzle of the paint spray gun at a constant paint spray gun distance based on the color of the paint.

17. The method of claim 14, wherein said determining a paint spray gun distance comprises determining a first paint spray gun distance for metallic colors and determining a second paint spray gun distance for solid colors that is less than the first paint spray gun distance.

18. The method of claim 14, further comprising determining a spray pattern based on the paint spray gun distance.

19. A tangible and non-transitory computer readable medium comprising one or more computer software modules configured to direct one or more processors to:
receive a color input relating to a color of paint for a workpiece;
determine a paint spray gun distance based on the color input, wherein different colors have different paint spray gun distances; and
position the nozzle of the paint spray gun at the paint spray gun distance while operating the paint spray gun.

20. The tangible and non-transitory computer readable medium of claim 18, wherein the computer readable medium is further configured to determine at least one of a spray pattern, a fluid flow rate, a volume of shape air, a speed of shape air, and a bell cup rotation speed based on the paint spray gun distance.
